(19) United States
(12) Patent Application Publication
(10) Pub. No.: US 2007/0279368 A1
(43) Pub. Date: Dec. 6, 2007

(54) Low intensity displays compatible with night vision imaging systems

(75) Inventor: Aaron P. Shefter, Coconut Creek, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: DRS Tactical Systems, Inc., Palm Bay, FL (US)

(21) Appl. No.: 11/219,017

(22) Filed: Sep. 1, 2005

Related U.S. Application Data
(60) Provisional application No. 60/606,377, filed on Sep. 1, 2004.

(51) Int. Cl. G09G 3/36

(52) U.S. Cl. 345/102

(57) ABSTRACT

An controllable intensity LCD display that provides normal or extremely low visible light and infrared intensity levels so as to be usable with military night vision gear (NVG) or Night Vision Imaging Systems (NVIS). The LCD display includes wide dynamic range backlight inverter power supply to extend the range of backlight dimming available with conventional cold cathode florescent (CCF) lights. An optional bridged power inverter provides yet further useable intensity reduction. Video controller RAMDAC palette programming further provides illumination attenuation using the LCD elements themselves. A ‘Hot Mirror’, i.e., infrared reflecting dielectric coatings, on various surfaces of the display's light path is used to further reduce infrared emissions.

### CROSS-REFERENCE TO RELATED APPLICATION

This application is based upon and claims priority from prior U.S. Provisional Application No. 60/606,377 entitled “Low Intensity Displays Compatible With Night Vision Imaging Systems” filed on Sep. 1, 2004 the entire disclosure of which is herein incorporated by reference in its entirety.

### BACKGROUND OF THE INVENTION

1. Field of the Invention

This invention generally relates to the field of electronic data displays, and more particularly relates to Liquid Crystal Displays that emit low intensity light so as to be suitable for use with night vision goggles and imaging systems.

2. Description of Related Art

Liquid Crystal Displays (LCDs) are able to display various types of data, such as numeric, alpha-numeric and pixel addressed, two dimensional graphical displays. One configuration for LCDs is to provide a backlight behind the liquid crystal panel to provide light that travels through the display and creates an illuminated display for the user. Cold Cathode Florescent (CCF) tubes are commonly used as a backlight source for LCDs. Backlit LCDs provide a well lit display that is able to be used in many applications. The use of a CCF tube as a backlight generally limits the range of illumination intensity that can be achieved for a particular application, particularly when using commonly available, and therefore inexpensive, components.

Devices with LCDs are sometimes desired to be used while wearing night vision goggles or with other low light imaging systems. The use of nigh vision goggles, for example, may accompany a desire to operate in a stealth mode where minimum visible light and infra-red energy is emitted by equipment. In order to enhance flexibility, some devices benefit from having an LCD that has two modes to allow that device and LCD to be used either with or without night vision goggles. These devices present a design challenge as the range of LCD image intensity is not able to be controlled over a range that provides both adequate intensity for use with unaided vision and that is then able to be reduced to allow for stealth, i.e., low visible and infra-red light radiation, usage with night imaging systems.

The common solution for providing display compatibility with Night Vision Equipment has been to use Infrared filters over the entire viewable display area to reduce the infrared emissions to an acceptable level. These filters absorb infrared energy but have the undesirable characteristic of significantly altering the colors that are ultimately viewed by the unaided human eye.

Low light level operation of Cold Cathode Fluorescent (CCF) bulbs requires that the gases contained within the bulb maintain their ionized state as power is reduced. If the bulb conducts electricity, it will generate light. If the gases lose ionization, the bulb extinguishes. An extinguished bulb requires ‘striking’ to restart the ionization process and produce light. It is not desirable, nor is it efficient to constantly ‘strike’ the bulb. As the energy provided by a single-ended backlight inverter to drive a bulb is reduced, one end of the bulb eventually ceases to provide light. The end of the bulb loosing light is losing ionization. This is the grounded end of the bulb. The end of the bulb driven with high voltage continues to emit light. As the energy is further reduced, more of the bulb ceases to provide light, until the energy supplied left only a small portion of the bulb still producing light on the high voltage side. This produces an uneven light emission profile along the CCF tube. If such a CCF tube is used as a backlight for an LCD, the LCD will exhibit an intensity gradient that corresponds to the uneven illumination of the backlight CCF tube and thereby results in one end of the display being “dark” or darker than the opposite end of the display.

Therefore a need exists to overcome the problems with the prior art as discussed above, and particularly for an LCD display with greater illumination range and that is also able to produce reduced infrared emissions while maintaining displayed color.

### SUMMARY OF THE INVENTION

According to a preferred embodiment of the present invention, a Liquid Crystal Display for use with low light imaging systems includes an LCD panel that has at least one LCD cell, a backlight positioned relative to the LCD panel so as to provide backlight illumination for the LCD panel and a backlight current controller that provides a tube current. The tube current being limited to a peak current that is adjustable by an external current control input. The liquid crystal display further includes a backlight controller that is configured to provide illumination control for the backlight. The backlight controller provides the tube current to the backlight, and the backlight controller sets a voltage provided to the backlight according to an external voltage control input.

The Liquid Crystal Display is also able to have a backlight controller that includes a bridged backlight inverter circuit and a “hot mirror” coating to reduce infrared emissions.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an electronic device incorporating an LCD display system in accordance with an exemplary embodiment of the present invention.

FIG. 2 illustrates an exemplary operating current to PWM relationship in accordance with an exemplary embodiment of the present invention.

FIG. 3 illustrates a single-ended backlight inverter circuit according to an alternative embodiment of the present invention.

FIG. 4 illustrates a bridged backlight inverter circuit using the dual control modes illustrated in FIG. 2, in accordance with an exemplary embodiment of the present invention.

FIG. 5 illustrates contrast offset values programmed into the RAMDAC palette for various levels of contrast enhancement according to an exemplary embodiment of the present invention.

FIG. 6 illustrates hot mirror coating placements on various transmissive surfaces in the LCD display system of FIG. 1 in accordance with exemplary embodiments of the present invention.

FIG. 7 illustrates alternative hot mirror coating placements on various transmissive surfaces in the LCD display system of FIG. 1 in accordance with exemplary embodiments of the present invention.

FIG. 8 illustrates a contrast enhancement table value calculation processing flow according to an exemplary embodiment of the present invention.

FIG. 9 illustrates NVIS boot-up configuration processing to ensure that a computer boots in its proper NVIS setting, according to an exemplary embodiment of the present invention.

FIG. 10 illustrates the follow-on boot processing flow, which follows the NVIS configuration boot processing shown in FIG. 9, according to an exemplary embodiment of the present invention.

FIG. 11 illustrates NVIS mode setting processing according to an exemplary embodiment of the present invention.

FIG. 12 illustrates NVIS mode switching processing according to an exemplary embodiment of the present invention.

FIG. 13 illustrates an NVIS mode switching software component processing flow according to an exemplary embodiment of the present invention.

FIG. 14 illustrates RAMDAC palette adjustment processing according to an exemplary embodiment of the present invention.

FIG. 15 illustrates side button processing according to an exemplary embodiment of the present invention.

### DESCRIPTION OF THE PREFERRED EMBODIMENTS

According to a preferred embodiment of the present invention, a LCD display backlight system is provided that has superior readability at extremely low visible light and infrared output levels using a single Cold Cathode Fluorescent (CCF) lamp as a backlight. This LCD does not emit sufficient visible or infrared intensity to interfere with the use of night vision systems, such as military night vision gear (NVG) or Night Vision Imaging Systems (NVIS). The display can be operated at low brightness levels so as to be viewed by personnel using NVG/NVIS. When operated at the lowest possible brightness levels, a display using this invention provides a very low light display, only viewable by the unaided human eye at distances less than 30-50 feet in complete darkness. This display can also have its backlight intensity increased so as to be easily viewed by unaided human eyes in a conventional manner.

The backlight of the exemplary embodiment of the present invention is powered by, and its intensity is controlled by, a backlight inverter. Embodiments of the present invention are able to use either single ended or bridged design, as is described below. The backlight inverter of the exemplary embodiment of the present invention provides power to a CCF tube lamp that is mounted in industry standard fashion such that the light generated by the CCF tube lamp is directed through the LCD panel and then ultimately through the display's external protective glass. As is described in detail below, the light emitted from the display, both visible and infrared emissions, is controlled and/or limited in this exemplary embodiment by several elements, including: a) the CCF bulb, as powered by the backlight inverter; b) the LCD display, via the video controller's operation; and c) one or more filters or Hot Mirrors included in the light path of the display. The backlight inverter controls the power provided to the CCF bulb and the subsequent brightness of the bulb. This light then travels through the LCD panel. As described below, the Video controller's RAMDAC palette is used to transform, i.e., to reduce, the intensity at which light is emitted from the LCD display. In order to maintain readability when the RAMDAC palette is programmed to reduce the transmitted light, the RAMDAC palette is also adjusted to enhance the display's contrast. Lastly, the light travels through the display's external protective glass, which is able to include a Hot Mirror coating.

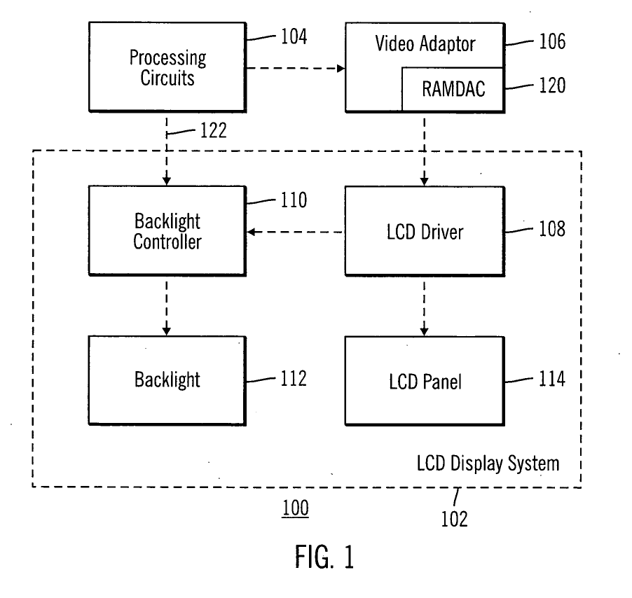

FIG. 1 illustrates an electronic device 100 incorporating an LCD display system 102 in accordance with an exemplary embodiment of the present invention. The exemplary electronic device 100 includes processing circuits 104 that produce data to be displayed by the LCD display system 102. Processing circuits 104 of the exemplary embodiment are able to include any type of data producing circuits, including, for example, a computer central processing unit (CPU) and support circuitry to perform any type of computer processing. The processing circuits of the exemplary embodiment provide data to be displayed in the LCD subsystem 102 to a video adaptor 106. Video adaptor 106 includes a RAMDAC 120 with a programmable palette, as is discussed in detail below. The Video adaptor 106 provides the output of the RAMDAC to the LCD display system 102, where it is received by an LCD driver 108. LCD driver 108 includes the support circuitry to properly drive the LCD panel 114, which is a two-dimensional array of color LCD picture elements (referred to as “pixels”), as is known to ordinary practitioners in the relevant arts.

LCD driver 108 further provides data to control a backlight controller 110. The backlight controller 110 of the exemplary embodiment provides power and illumination intensity control to a backlight 112. Backlight 112 provides backlighting for the LCD panel 114 as is described in detail below. Backlight controller 110 is also described in much further detail below. The Backlight controller 110 further receives intensity commands 122 from the processing circuits 104 that control the intensity of light produced by the backlight 112. For example, intensity commands 122 produce commands that indicate if the intensity of the LCD display system output is to be at a “normal” level or at an “NVIS” level. “NVIS” level indicates that the LCD display system should produce an output suitable for use with Night Vision Imaging Systems (NVIS), i.e., a very low level of output illumination intensity.

The operation of the exemplary embodiment of the present invention uses a “bridged” backlight inverter as part of the backlight controller 110 to extend the dimmest operating level of the CCF bulb used as a backlight 112. As compared to conventional single ended backlight inverter, the bridged backlight inverter improves the uniformity of light emissions along the length of the bulb. In the case of a conventional single—ended backlight inverter, one end of the bulb eventually ceases to provide light because it is losing ionization as energy provided to CCF bulb is reduced. The end of the CCF bulb that ceases to provide light is the grounded end of the bulb. The end of the CCF bulb driven with high voltage continues to emit light. As the energy delivered to the CCF bulb by the single—ended backlight inverter is further reduced, more of the CCF bulb ceases to provide light until only a small portion of the CCF bulb produces light on the high voltage side. It was surmised that the voltage swing on terminal of the CCF bulb that is not the grounded terminal helps to produce light.

To improve the uniformity of emissions along the length of the CCF bulb, the exemplary embodiment of the present invention includes a bridged backlight inverter circuit that provides high voltage to both ends of the CCF bulb. This bridged design provides voltage to both ends of the bulb. In this configuration, the light output is reduced in the middle of the bulb rather than at one end as power is reduced and the bulb begins to lose the ability to produce light. The optical light diffusers (not shown) used in the LCD display system 102 tend to mask the loss of light at the middle of the bulb. These diffusers of the LCD display subsystem do not, however, mask the loss light on one side of the bulb as well. Therefore loosing illumination intensity in the middle of the bulb is preferable, hence the use of the bridged backlight inverter provides a superior dim bulb capability in the exemplary embodiment. The bridged backlight inverter circuit has been observed to exhibit acceptable uniform operation down to 0.15 NITS, thereby providing a dynamic range in excess of 1300 to 1.

The exemplary embodiment incorporates a backlight inverter with a controllable dynamic range that is greater than and that overlaps the bulb's operating dynamic range in order to utilize the bulb's full potential illumination operating range. To increase the controllable dynamic range of a standard backlight inverter, a combination pulse width modulation (PWM) and bulb current control methods are used to control the intensity of the light emitted from the CCF bulb. The resulting backlight inverter's controllable dynamic range is thereby able to be in excess of 2000 to 1. Prior art backlight controllers use one of either pulse width modulation (PWM) or bulb current control individually. The exemplary embodiment of the present invention simultaneously combines both of these control techniques to advantageously extend the controllable operating range of conventionally available CCF controller devices by commonly controlling bulb current and bulb voltage in response to the pulse with modulation input control input. This common adjustment in the exemplary embodiment is performed in a simultaneous and coordinated manner. Prior art systems often include two light sources and/or bulbs that have multiple sets of electrical contacts in order to support operation with Night Vision Goggles (NVG). The exemplary embodiment of the present invention advantageously uses a single, simpler bulb and thereby reduces complexity, weight, cost and improves reliability of the LCD display system 102.

One of the problems solved by the exemplary embodiments of the present invention for low output illumination operation is ensuring that the minimum energy is applied to the bulb to keep the gases ionized while limiting the light emitted by the bulb to the lowest possible level. The wide dynamic range backlight inverter used by the exemplary embodiment provides improved operations by advantageously ensuring that the minimum amount of energy is applied to the bulb that will keep the gases ionized, while simultaneously limiting the light emitted by the bulb to the lowest possible level. The backlight inverter of the present invention maintains the bulb's gas ionization at lower light output levels by controlling intensity through a combination of pulse width modulation (PWM) and current control. An added benefit of controlling both PWM and current simultaneously in the manner of the exemplary embodiment is that a linear control input results in an exponential intensity output characteristic. This advantageously matches the human eyes' logarithmic operation and provides a more natural operation for the user.

Exemplary Backlight Inverter Design

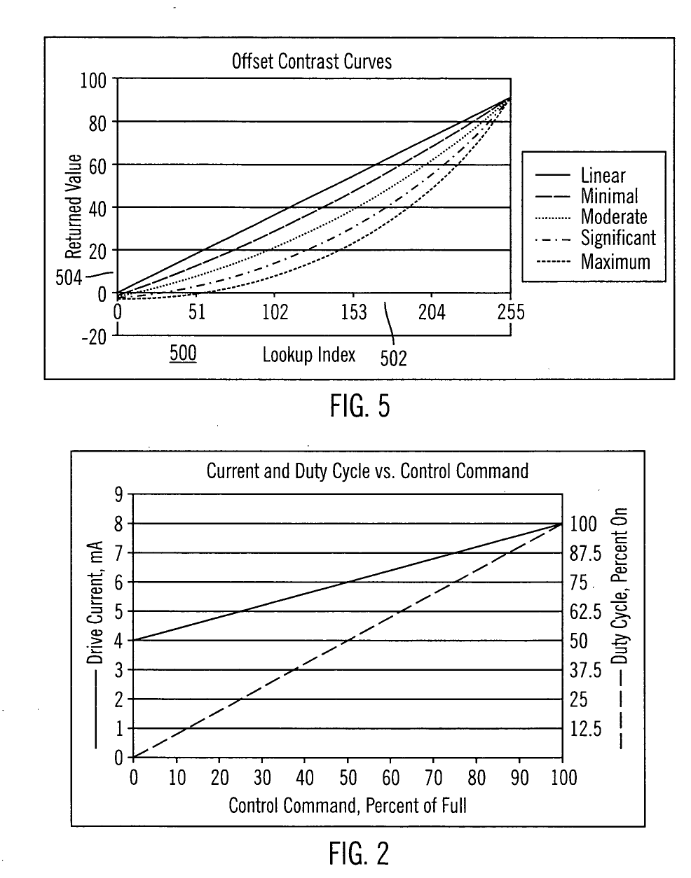

FIG. 2 illustrates an exemplary operating current to PWM relationship 200 in accordance with an exemplary embodiment of the present invention. Various embodiments of the present invention are able to operate with a variety of backlight inverter designs. The backlight inverter of the exemplary embodiment supports the simultaneous variation, independently or with a pre-determined relationship, of both the operating current and the duty cycle of pulse width modulation (PWM) from minimum levels to maximum levels. The exemplary operating current to PWM relationship 200 shows that an input command to the backlight controller that increases linearly from minimum to maximum causes the drive current to vary linearly from 4 to 8 milliamps while the PWM duty cycle varies linearly from 1/255 to 1 (i.e., 255/255), given the 8 bits of precision for the PWM generator in this embodiment. Other relationships are also possible including non-linear variations of the output current or PWM with respect to linear intensity commands variations. The operational scenario is achieved by maintaining a minimum level of ionization within the bulb so that a need to restrike the bulb is reduced.

The wide dynamic range backlight inverter circuit of the exemplary embodiment uses an integrated circuit that was designed to be used in either a varying current or varying PWM mode, but not to be used in an environment where both are varied. The Backlight Inverter of the exemplary embodiment uses a LX1689 from MicroSemi, Inc, Irvine, Calif. 92614 as the main control unit. The exemplary embodiment advantageously exploits that integrated circuit's design in a way not thought of by its designers to simultaneously modulate both of these quantities.

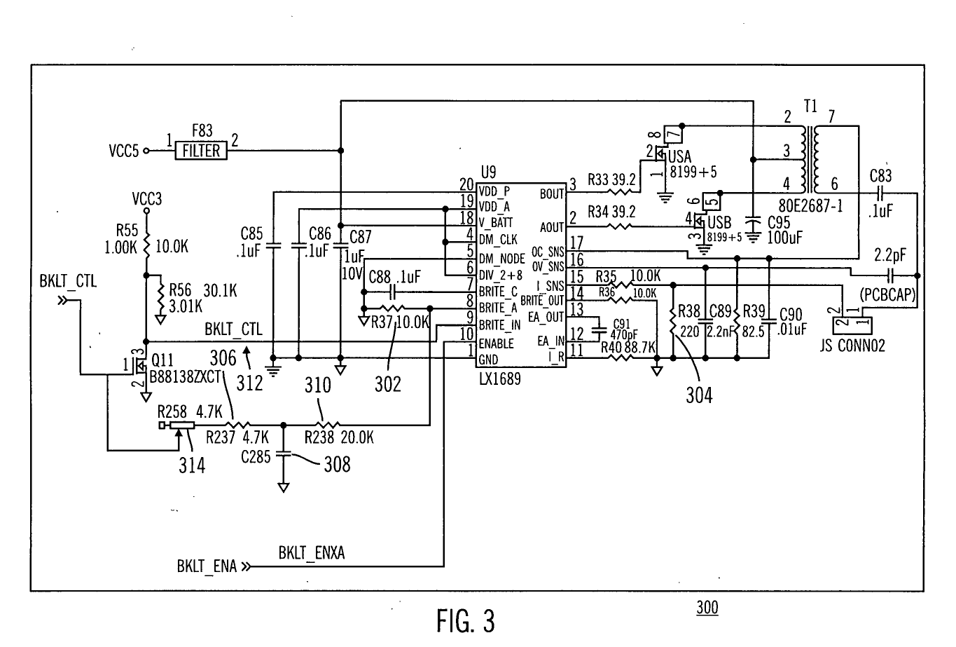

FIG. 3 illustrates a single-ended backlight inverter circuit 300 according to an alternative embodiment of the present invention. The single-ended backlight inverter circuit 300 indicates components that have been added or changed from a conventional LX1689 supporting circuit in order to implement the dual control method of the exemplary embodiment. R38 304 is used to develop a voltage to measure the lamp current. R37 302 is used to set the bulb operating current. R237 306 and C285 308 form a low pass filter slower than the PWM rate. The magnitude of R258 314+R237 306+R238 238 sets the magnitude of drive current variation. The Pulse Width Modulation signal BKLT_CTL 312 is supplied in the exemplary embodiment from an external control circuit that is used to vary the brightness of indicator LED (not shown), via PWM of the LEDs' power source, located about the electronic device (not shown) driving the LCD.

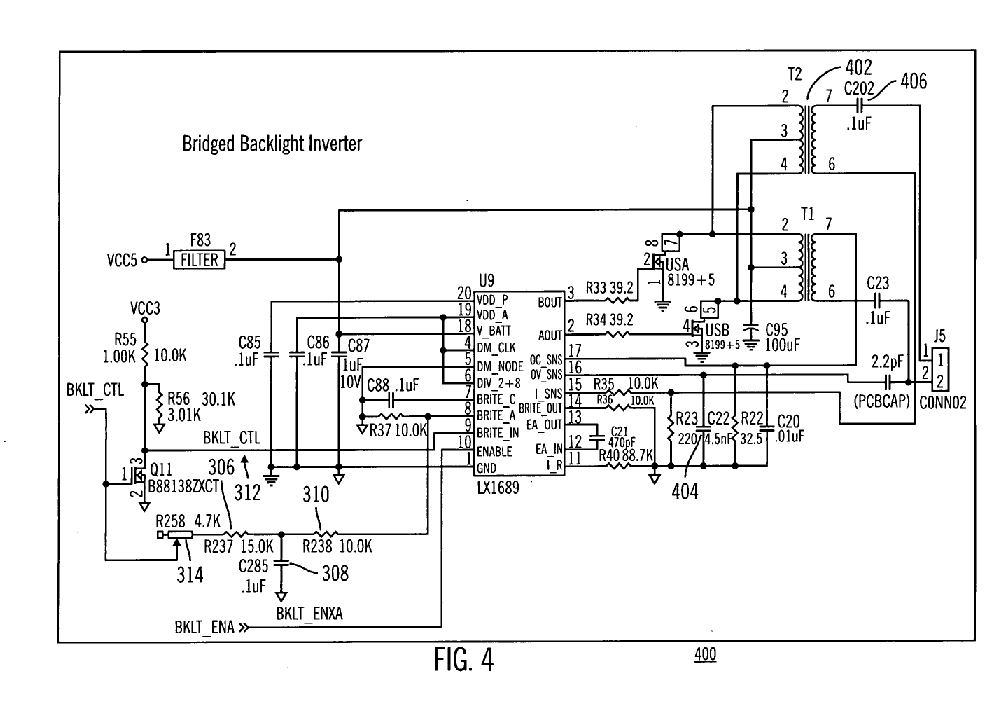

FIG. 4 illustrates a bridged backlight inverter circuit 400 using the dual control modes illustrated in FIG. 2, in accordance with an exemplary embodiment of the present invention. The bridged backlight inverter circuit 400 differs from the single—ended backlight inverter circuit 300 by, for example, the addition of a second high-voltage transformer 402, an additional capacitor 406, and rerouting the original transformer's secondary return lines. The configuration of the bridged backlight inverter circuit 400 essentially uses one transformer for providing operating current feedback and a second transformer for over current protection. C89 404 is adjusted to set the under voltage protection threshold and is set for one half of voltage in the exemplary embodiment. Further embodiments implement a similar circuit with a single transformer of suitable design in order to reduce the cost and part count for the circuit.

The exemplary embodiment of the present invention advantageously uses the programmable RAMDAC Palette of the video adaptor 106 driving the LCD display system 102 to reduce light levels emitted by the LCD display system 102. The RAMDAC palette of the exemplary embodiment is reprogrammed to reduce the intensity of all input color values. Conventionally, RAMDAC Palette programming is used to ensure that the colors, intensities, contrast and brightness of a video display are most realistic and properly match the hardcopy produced by various output devices. In the operation of the exemplary embodiment of the present invention, however, some loss in the degree of realism in the rendering of colors may be tolerated in order to gain a more readable display at the lowest possible brightness level (intensity). The exemplary embodiment enhances the display's contrast as part of RAMDAC Palette programming. This process of programming of the video controller's RAMDAC Palette to reduce the brightness and enhance the contrast of the display is referred to herein as ‘RAMDAC Dimming’. Since the level that a CCF Bulb's brightness can be reduced before the bulb loses ionization and extinguishes is generally too bright for use with night vision equipment, the concept of ‘RAMDAC Dimming’ provides a technique to further reduce the emitted display illumination to levels suitable for use with night vision goggles. Using a combination of RAMDAC Dimming and a wide dynamic range backlight inverter allows a standard CCF Bulb based backlight system to be created that limits the output level of visible light to a level that is compatible with the use of night vision equipment and stealth operations.

The exemplary embodiment of the present invention has demonstrated superior performance over conventional designs. An industry standard CCF bulb that has an 8 Bit PWM controller and that uses standard power supply designs only exhibits a dynamic range of 50:1 due to several limitations. One limitation of such a conventional power inverter is that the controller would not let the bulb operate below 4 NITS. A second problem is that uniform emission of light along the length of the bulb is lost below 1.5 NITS of brightness, as measured on the screen, due to the use of a single-ended power supply. Although light emissions are not uniform along the length of the bulb at 0.75 NITS of brightness, the screen of this conventional design still appears to be acceptably uniform. Below this level, however, the lack of uniformity is noticeable to the user because one side of the display appears much dimmer than the other due to the design that only applies high voltage to one side of the bulb while keeping the other side of the bulb at ground potential.

The exemplary embodiment of the present invention demonstrated improved performance over that conventional display. The bridged backlight inverter of the exemplary embodiment advantageously reduced the minimum uniform illumination level to 0.150 NITS. The exemplary embodiment further incorporates a Hot Mirror coating to reduce infrared emissions. The exemplary embodiment further adds RAMDAC palette dimming, with an illumination reduction factor of ⅛th, to allow the display to achieve acceptably uniform operation as low as 0.020 NITS. An overall dynamic range of 10,000 to 1 is thus achieved with the exemplary embodiment with minimal loss of color balance or contrast.

Video Controller RAMDAC Palette Dimming

A transmissive LCD display can be thought of as an electronically programmable light filter mechanism. It controls the amount of Red, Blue and Green light that is transmitted by each pixel of the display. One design option to selectively reduce the illumination output of an LCD display is to place an electronically controllable light filter between the LCD panel and the external protective glass to optionally limit visible light transmission under electronic control. The exemplary embodiment of the present invention uses the LCD panel itself to reduce the brightness of the display. The exemplary embodiment of the present invention uses a video controller that supports RAMDAC palette adjustments to implement this function.

A RAMDAC palette generally consists of 3 translation tables held in the video controller's memory, one each for Red, Blue and Green pixels. In the exemplary embodiment of this invention, each table of the RAMDAC palette allows programming of output values that correspond to input values of 0 through 255. These three output values are each provided to a Digital to Analog Converter (DAC) that produce analog voltages used to drive each pixel-color element in the LCD panel. In normal operation, these tables are loaded with a 1 to 1 equal illumination level translation, effectively causing no changes to be made. A squared relationship exists between the value supplied as an input to the RAMDAC Palette and the corresponding change in the measured output produced by the DAC. For example, a linear translation table at 50% yields a linear output at 25% of the original intensity. The exemplary embodiment of the present invention reduces this output level by at least a factor of 8 using the RAMDAC palette. For example, a maximum input brightness command of 255 is translated to (255/2.8), or 91, by the RAMDAC palette of the exemplary embodiment (where 2.8 is approximately the square root of 8).

It was found that a linear curve for input to output intensities programmed into the RAMDAC palette resulted in loss of display contrast. Altering the shape of the translation curve improves display contrast and consequentially improves the readability of the display. The amount of contrast enhancement that is configured in the exemplary embodiment to maintain display quality is proportional to the level of dimming that is programmed into the RAMDAC palette. At the same time, excess contrast enhancement should be avoided as it also affects the display's appearance.

FIG. 5 illustrates contrast offset values 500 programmed into the RAMDAC palette for various levels of contrast enhancement according to an exemplary embodiment of the present invention. The horizontal axis illustrates the input intensity to the RAMDAC, which varies from 0 to 255 according to the eight bit input to each color of the RAMDAC. The vertical axis illustrates the value programmed into the RAMDAC palette that is returned in response to the input according to the selected amount of contrast enhancement indicated by one of the five illustrated curves. To demonstrate the relationship between contrast enhancement and dimming, ‘minimal’ contrast enhancement is considered to be optimal when dimming is set to ½ of normal intensity. ‘Moderate’ contrast enhancement is considered to be optimal when dimming is set to ¼th of normal intensity while ‘Significant’ contrast enhancement is considered optimal when dimming is set to ⅛th of normal intensity and ‘Maximum’ contrast enhancement is considered best when dimming is set to 1/16th of normal intensity.

Hot Mirror Coating

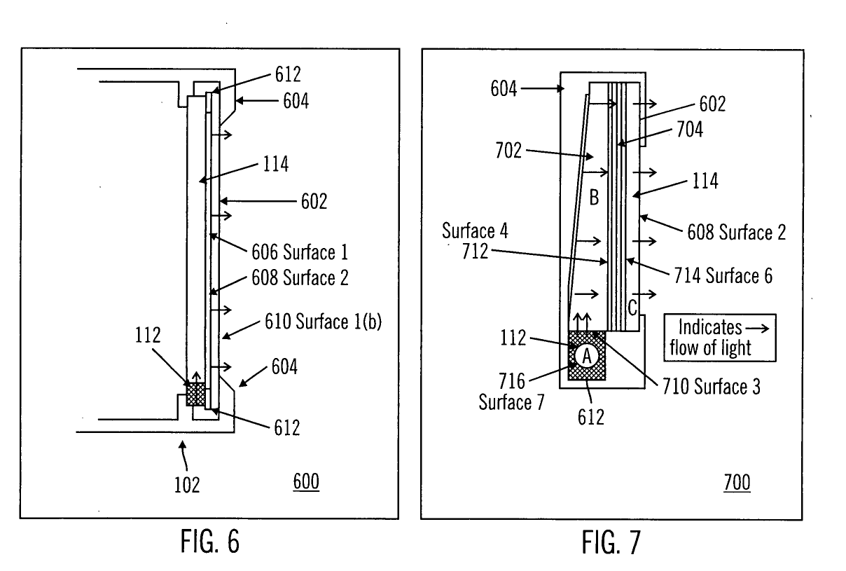

FIG. 6 illustrates hot mirror coating placements 600 on various transmissive surfaces in the LCD display system 102 in accordance with exemplary embodiments of the present invention. The external protective glass 602 is the outer most component of the LCD display system 102. The outside surface 1(b) 610 of the external protective glass 602 is closest to the user who views the display. The LCD panel 114 is mounted behind the external protective glass 602 and is separated from the external protective glass by spacer 612. The inside surface 1 606 of the external protective glass is toward the LCD display. The exemplary embodiment of the present invention applies a Hot Mirror coating onto the inside surface 1 606 of the external protective glass 602. With the coating applied at this location, infrared energy directed toward the glass 602 from the inside of the computer to be reflected back into the computer, thereby greatly reducing infrared emissions. The hot mirror coating is also able to be applied to surface 2 608 of the LCD panel 114 or surface 1(b) 610.

FIG. 7 illustrates alternative hot mirror coating placements 700 on various transmissive surfaces in the LCD display system 102 in accordance with exemplary embodiments of the present invention. The alternative hot mirror coating placements 700 illustrates an LCD panel 114 with a backlight 112 that provides light to a backlight prism 702. The backlight prism transmits light through various diffusers and/or filters 704 to the LCD panel 114 and out through the external glass 602. Examples of placement locations for the hot mirror coatings include placement on the outside of external glass 602, i.e., surface 2 608, the backlight prism input surface 3 701, the backlight prism output 712, on the LCD panel back surface 6 714 and/or on the backlight bulb itself, i.e., surface 7. Note that the coating may be applied directly to a surface or alternatively, the coating can first be applied to a substrate and subsequently the substrate containing the coating can be applied to the surface. Hot mirror coatings can also be alternatively or additionally placed on any other suitable light transmissive surface. An example embodiment of this invention uses a commercially available Hot Mirror coating Abrisa Coating Z103, from Abrisa, Inc. Santa Paula, Calif. 93060.

Processing Control Software

The software and firmware used to implement these improvements presents two distinct operating modes to the user, is easy to use and provides a number of configurable options to the user so that they may setup its operation to best suit their individual needs. Software and firmware are used to both configure and control the operation of the hardware components to provide an overall user friendly ‘system’. The system configuration software allows the user to directly adjust the intensity level of the display, select user configured parameters such as the default operating levels in each mode, the selected ‘boot’ mode (the mode to be used when the computer is started), and the selected use of the computer's side buttons.

The system configuration software provides non-volatile storage for all levels and options selected. The Mode Switching software simply switches between modes—either “normal” mode with unreduced LCD display system intensity or “NVIS” mode which has reduced LCD display system intensity so as to be compatible with NVIS equipment, such as night vision goggles. The NVIS startup service holds off bulb turn on, when starting in NVIS mode, until such time that the system has booted to the point that the RAMDAC palette is fully functional and thereby can configure the RAMDAC palette for reduced light output. The system configuration software is synchronized with the mode switching software so that it properly indicates the current operating mode and displays appropriate intensity setting on the user interface's adjustment slider. The enhanced firmware provides hardware level shifting between operating modes and ensures that the system boots in the correct mode. The control software described below is able to be incorporated into a computer's firmware to ensure proper computer operation, even during power up. In the context of this description, a computer's firmware includes software stored in any non-volatile storage, including the computer's Basic Input/Output System (BIOS).

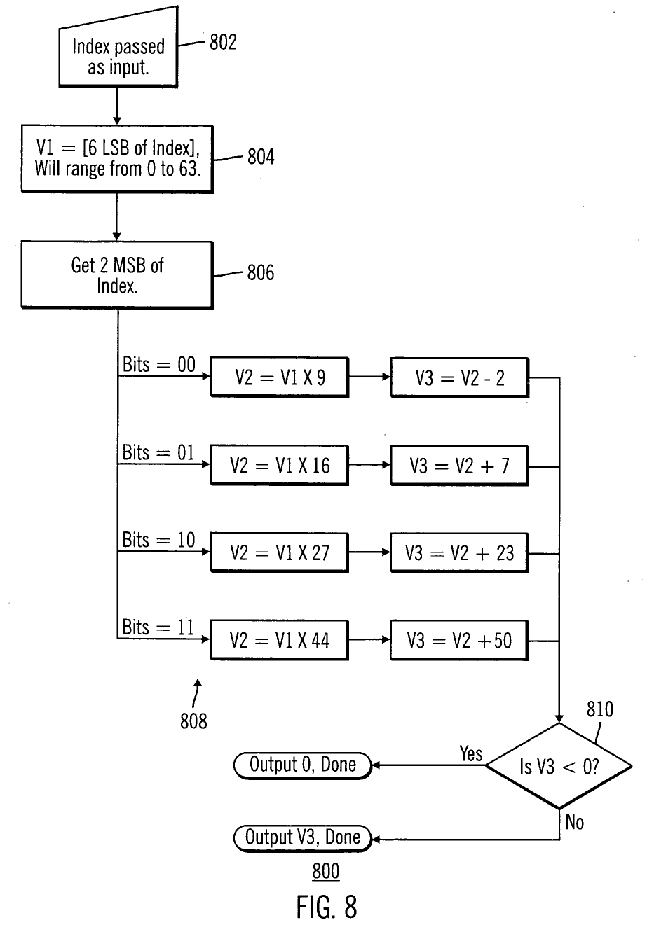

FIG. 8 illustrates a contrast enhancement table value calculation processing flow 800 according to an exemplary embodiment of the present invention. The contrast enhancement table value calculation processing flow 800 creates a four segment piecewise approximation of a selected dimming curve with contrast enhancement as is illustrated in FIG. 5. The values calculated by the contrast enhancement table value calculation processing flow 800 are loaded into the RAMDAC palette table when operating in low emission NVIS mode. The processing of this contrast enhancement table value calculation processing flow 800 is particularly straight forward and is able to be easily implemented in assembly language programming as is normally chosen for an interrupt handler or ACPI control method. The contrast enhancement table value calculation processing flow 800 begins by receiving, at step 802, an index for the RAMDAC palette table. The processing then extracts, at step 804, the six least significant bits of the received index. The processing next selects the two most significant bits of the received index 806 and performs the scaling and translation indicated by steps 808. The processing next determines, at step 810, if the output is less than zero and clips the output to be greater than zero.

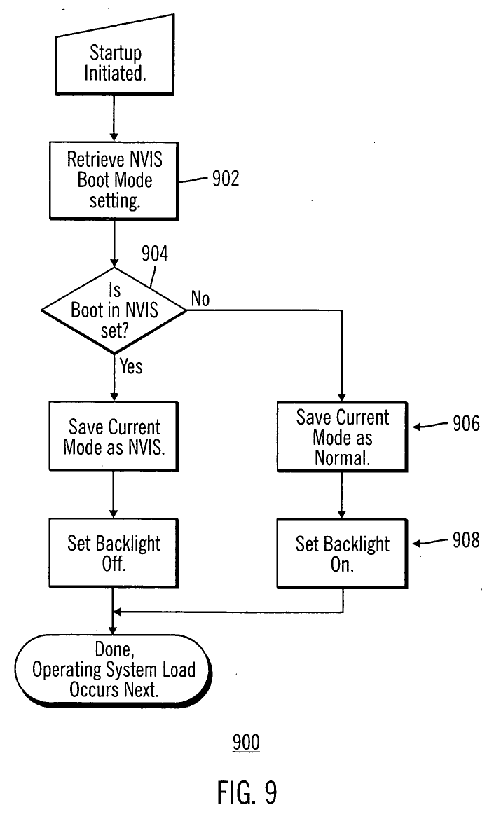

FIG. 9 illustrates NVIS boot-up configuration processing 900 to ensure that a computer boots in its proper NVIS setting, according to an exemplary embodiment of the present invention. The NVIS boot-up configuration processing 900 begins by retrieving, at step 902, the NVIS boot mode setting. The NVIS boot mode setting is a configuration parameter that is stored in non-volatile memory in the exemplary embodiment. Based upon the value of the NVIS boot mode setting, the computer configurably operates to ensure that the backlight is off during power up until the video adapter 106 is configured to operate in a low intensity mode if NVIS mode is selected, thereby forcing the computer to boot in either a normal or NVIS mode. The processing next determines, at step 904, if the computer is configured to boot in NVIS mode. The processing next prepares for boot processing by saving, at step 906, the current NVIS boot mode for reading by follow-on boot processing and properly configuring, at step 908, the back light as either on or off. Boot processing for the computer then proceeds.

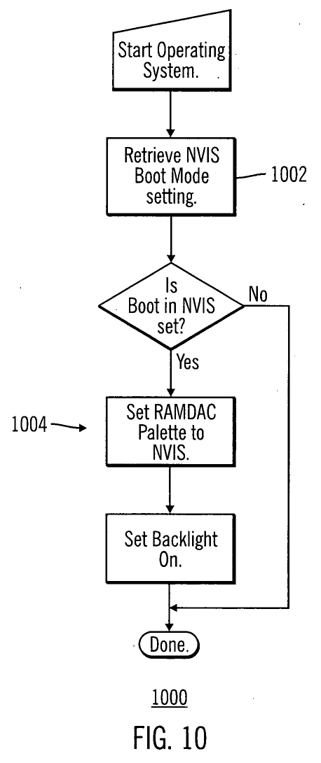

FIG. 10 illustrates the follow-on boot processing flow 1000, which follows the NVIS configuration boot processing 900, according to an exemplary embodiment of the present invention. The follow-on boot processing begins by retrieving, at step 1002, the NVIS boot mode setting that was stored by the NVIS boot-up configuration processing 900. If NVIS mode is set, the processing sets, at steps 1004, the RAMDAC palette to NVIS mode and sets then sets the backlight to on. This processing flow ensures that the LCD panel 114 is configured to attenuate the illumination output of the LCD display system 102 prior to turning on the backlight. This advantageously eliminates a “flash” of light at computer startup.

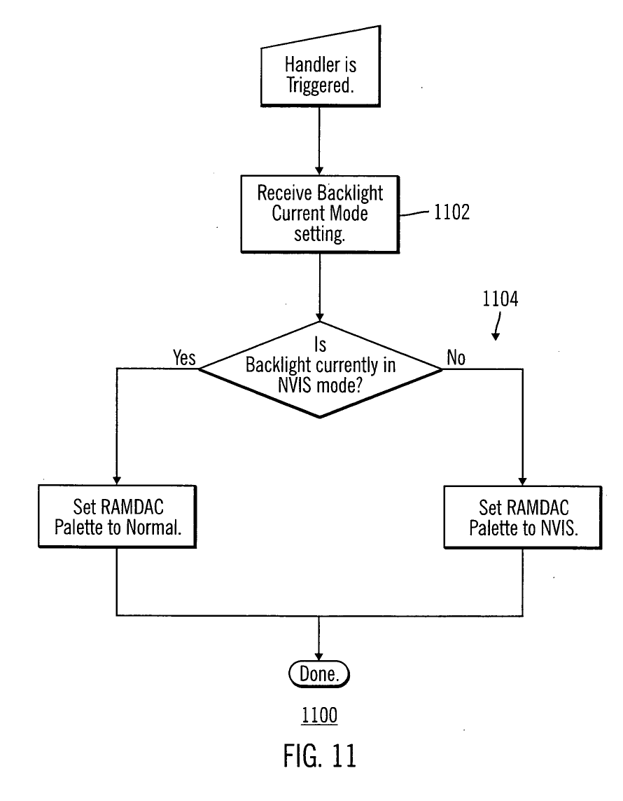

FIG. 11 illustrates NVIS mode setting processing 1100 according to an exemplary embodiment of the present invention. The NVIS mode setting processing 1100 begins by retrieving, at step 1102, the current backlight mode setting. The processing then sets, at steps 1104, the RAMDAC palette according to the current backlight setting. Setting of the RAMDAC palette is described in detail above.

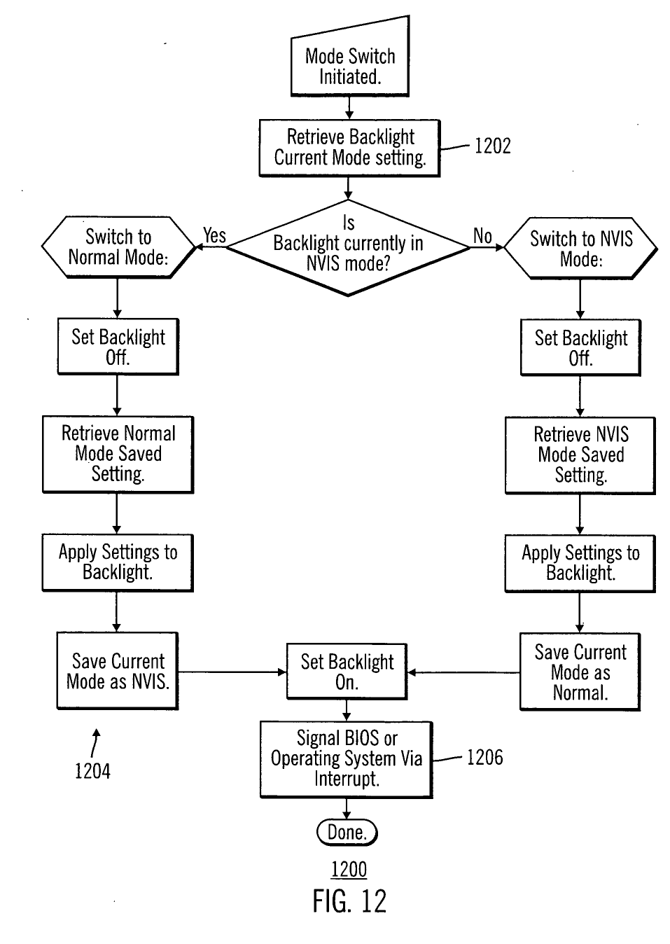

FIG. 12 illustrates NVIS mode switching processing 1200 according to an exemplary embodiment of the present invention. The processing begins by retrieving, at step 1202, the current backlight mode setting. The processing then switches, at steps 1204, the backlight mode by turning the backlight off, retrieving the mode settings for the new mode, applying those settings, and turning the backlight on. The processing of the exemplary embodiment then signals, at step 1206, the computer's BIOS (i.e., the Basic Input/Output System) or operating system through an interrupt. This interrupt in the exemplary embodiment causes the ACPI/interrupt handler to execute changing the RAMDAC palette table contents.

In the exemplary embodiment, the processing is defined for ACPI operating systems and non-ACPI operating systems. Under ACPI operating systems, a specific, predefined code is passed indicating that the RAMDAC palette table is to be updated. Using ACPI definitions, an SCI is sent rather than an interrupt. In non-ACPI control, the mode transition is handled by a specially configured interrupt handler.

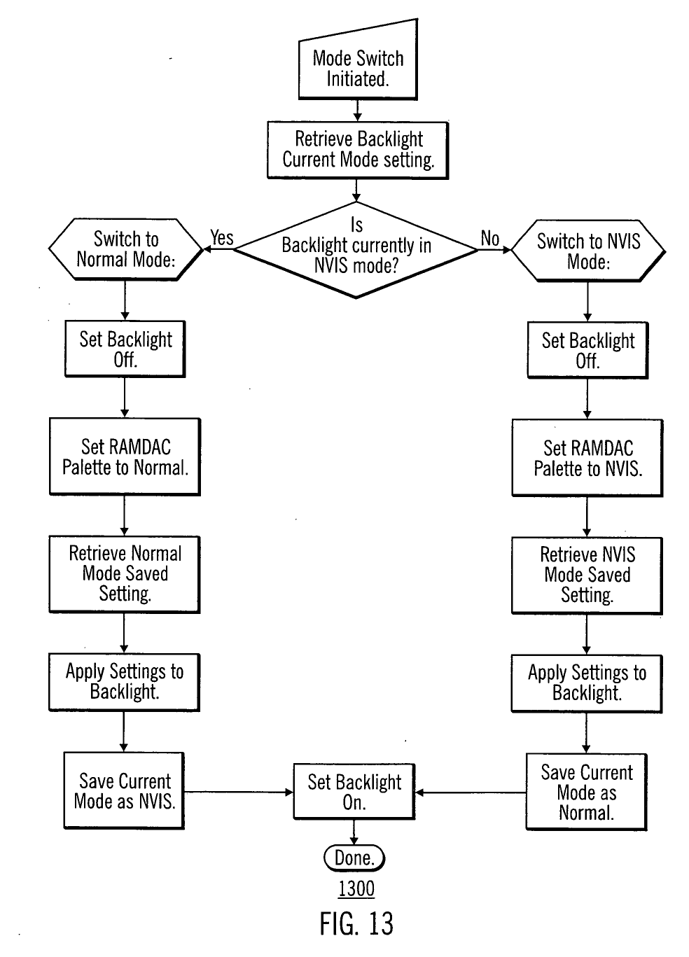

FIG. 13 illustrates an NVIS mode switching software component processing flow 1300 according to an exemplary embodiment of the present invention. The NVIS mode switching software component processing flow 1300 operates similarly to the NVIS mode switching processing 1200 but changes the RAMDAC palette directly and does not include interrupt generation to effect that processing.

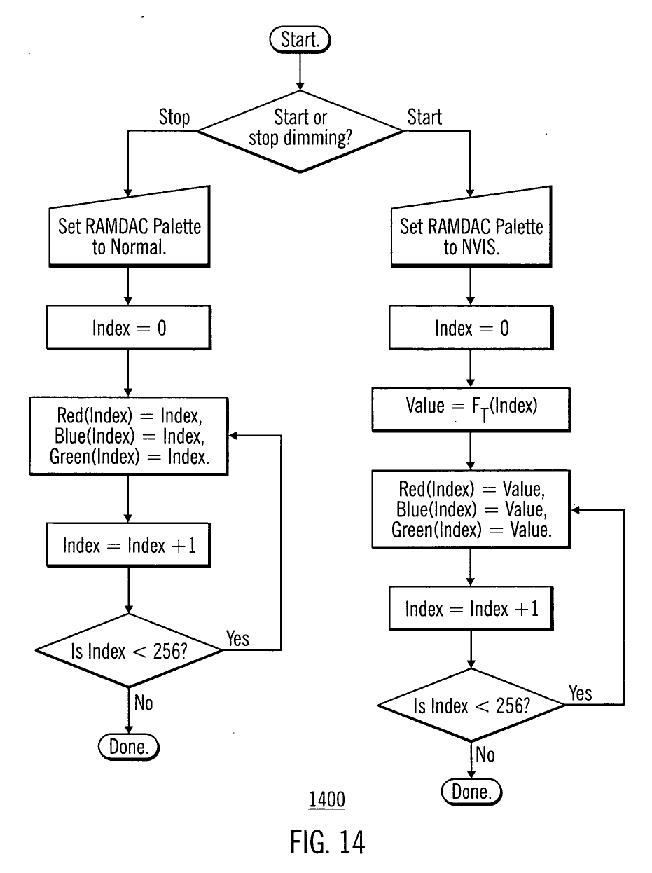

FIG. 14 illustrates RAMDAC palette adjustment processing 1400 according to an exemplary embodiment of the present invention. This processing begins by determining, at step 1402, if NVIS dimming is to start or stop. The processing then adjusts, at steps 1404, the RAMDAC palette. In the case of dimming the RAMDAC palette, the processing calculates a value to be stored in each RAMDAC table entry that is identified as Fₜ(index). This entry is given by the following equation:
Fₜ(index)=14.1*e^{(index/125)}−16.6, where 0≦index≦255

The exemplary embodiment of the present invention adjusts this equation to facilitate implementation in a digital processor by using the following equation:
Fₜ(index)=14.1*2^{(index/86)}−16.6, where 0≦index≦255

This equation if further simplified by using a four piece approximation as illustrated in FIG. 8.

The exemplary embodiment operates on a laptop computer with side buttons, and the software of the exemplary embodiment allows a user to configure the computer's side button's use. When a side button is pressed, this setting can: cause the backlight to toggle between on and off, cause the computer to toggle between NVIS and Normal mode or send a trigger to Windows, so that Windows can process the button press. The user is also able to enable automatic dimming in low light and /or enable automatic backlight turn off in bright light, a power saving feature used with transfiective LCD displays. These functions use a light sensor built into the computer.

Screen brightness can also be adjusted in both operating modes through user interfaces provided by the software of the exemplary embodiment. The values set by operation of this software are used as the default values wherever either mode is entered. In addition to the control software, hardware based brightness adjustments are available in the form of push button switches for brightness ‘UP’ and ‘DOWN’. When these switches are used to adjust the brightness, the default values are not changed in the exemplary embodiment, although further embodiments do change the default values in response to these inputs. The brightness can be lowered to the point of causing the backlight to be extinguished. When this occurs, the hardware brightness ‘UP’ button is used to restart the backlight, ‘striking’ the bulb every time the switch is pressed. The use of the brightness ‘UP’ and ‘DOWN’ buttons implements a progressive adjustment algorithm when they are pressed and held. Step sizes increase the longer the button is held. This is used to reduce time required for large transitions of the brightness setting.

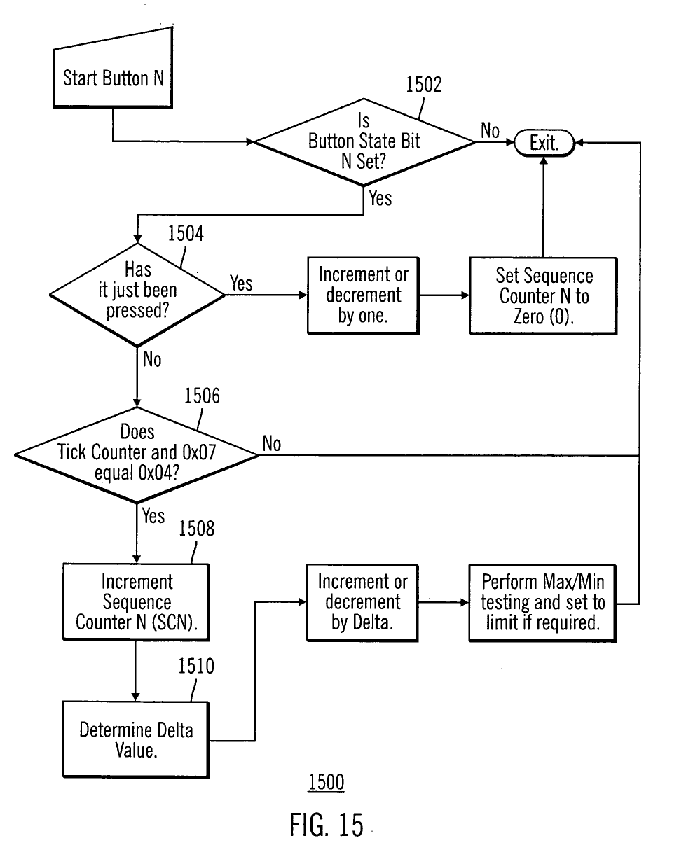

FIG. 15 illustrates side button processing 1500 according to an exemplary embodiment of the present invention. The processing for “Button N” is illustrated, where “N” is one of “UP or “DOWN.” As discussed above, the processing of the side button processing implements a progressive adjustment algorithm. The processing determines, at step 1502, if the button is pressed. If the button is pressed, the processing determines, at step 1504, if the button has just been pressed. If the button has just been pressed, the value is simply incremented and the “sequence counter” (SCN) is set to zero. If the button has not just been pressed, this indicates that the user is holding the button in its depressed state and that progressive adjustment is required. The time that the button has been depressed is determined, at step 1506. This check allows four adjustments per second. Further embodiments can use different or user adjustable increment frequencies. The value of the “sequence counter” (SCN) is incremented, at step 1508. The value of “delta,” i.e., the value by which the setting is changed, is determined based on the sequence counter value (SCN). The exemplary embodiment sets delta equal to “0” for SCN values 1-3, sets delta equal to “1” for SCN values equal to 4-7, sets delta equal to “2” for SCN values of 8-11, sets delta equal to “4 for SCN values 12-15 and sets delta equal to “8” for SCN values greater than 16.

The present invention can be realized in hardware, software, or a combination of hardware and software. A system according to an exemplary embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least one computer readable medium that allows the computer to read data, instructions, messages or message packets, and other computer readable information. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

The terms “a” or “an”, as used herein, are defined as one or more than one. The term plurality, as used herein, is defined as two or more than two. The term another, as used herein, is defined as at least a second or more. The terms including and having, as used herein, are defined as comprising (i.e., open language). The term coupled, as used herein, is defined as connected, although not necessarily directly, and not necessarily mechanically.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A Liquid Crystal Display for use with low light imaging systems, the liquid crystal display comprising:
an LCD panel comprising at least one LCD cell;
a backlight positioned relative to the LCD panel so as to provide backlight illumination for the LCD panel;
a backlight current controller that provides a tube current, the tube current being limited to a peak current, the peak current being adjustable by an external current control input; and
a backlight controller configured to provide illumination control for the backlight, the backlight controller providing the tube current to the backlight, and the backlight controller setting a voltage provided to the backlight according to an external voltage control input.

2. The Liquid Crystal Display according to claim 1, wherein the backlight controller comprises a bridged backlight inverter circuit.

3. The Liquid Crystal Display according to claim 1, wherein the backlight controller comprises a conventional backlight inverter integrated circuit.

4. The Liquid Crystal Display according to claim 1, further comprising a light filter, the light filter filtering light produced by the backlight and comprising a light transmissive surface with a hot mirror coating.

5. The Liquid Crystal Display according to claim 4, wherein the light transmissive surface is between the backlight and the LCD panel.

6. The Liquid Crystal Display according to claim 1, wherein the external voltage control input comprises a pulse width modulated waveform.

7. The Liquid Crystal Display according to claim 6, wherein the tube current and the voltage provided to the backlight are commonly adjusted in response to the pulse width modulated waveform.

8. The Liquid Crystal Display according to claim 1, wherein each of the at least one LCD cell comprises a plurality of color elements, the Liquid Crystal Display further comprising an LCD panel controller for controlling the at least one LCD cell, wherein the LCD panel controller comprises a RAMDAC and a RAMDAC palette, the RAMDAC palette being configured to reduce the total brightness output of all color elements in each of the at least one LCD cell so as to reduce the total light output of the Liquid Crystal Display.

9. The Liquid Crystal Display according to claim 8, further comprising processing circuits for providing data to the LCD panel controller to display on the LCD panel, the processing circuits providing a switchable control to change at least one of the backlight controller, the backlight current controller, and the LCD panel controller from a low intensity mode suitable for use with night vision imaging systems to a high intensity mode suitable for unaided visual use.

10. The Liquid Crystal Display according to claim 9, wherein at least one of the panel controller, the backlight current controller and the backlight controller operate to provide adjustable brightness control.

11. The Liquid Crystal Display according to claim 9, wherein the processing circuits configurably operate, based on a configuration parameter, at least one of the backlight controller and the backlight current controller to ensure the backlight is off during power up of the processing circuits until the LCD panel controller is configured to operate in a low intensity mode.

12. The Liquid Crystal Display according to claim 9, wherein the processing circuits comprise a computer and executable code to configurably operate, based on a configuration parameter, at least one of the backlight controller and the backlight current controller to ensure the backlight is off during power up of the processing circuits until the LCD panel controller is configured to operate in a low intensity mode resides in the computer's firmware.

13. A method for controlling a Liquid Crystal Display for use with low light imaging systems, the method comprising:
an LCD panel comprising at least one LCD cell;
positioning a backlight relative to a LCD panel so as to provide backlight illumination for the LCD panel;
providing a tube current, the tube current being limited to a peak current, the peak current being adjustable by an external current control input; and
provide illumination control for the backlight through a controller providing the tube current to the backlight, the providing illumination control comprising setting a voltage provided to the backlight according to an external voltage control input.
